(19) United States
(12) Patent Application Publication
(10) Pub. No.: US 2024/0087289 A1
(43) Pub. Date: Mar. 14, 2024

(54) IMAGE PROCESSING APPARATUS, IMAGE PROCESSING METHOD, AND NON-TRANSITORY COMPUTER-READABLE STORAGE MEDIUM

(71) Applicant: NEC Corporation, Minato-ku, Tokyo (JP)

(72) Inventor: Noboru Yoshida, Tokyo (JP)

(73) Assignee: NEC Corporation, Minato-ku, Tokyo (JP)

(21) Appl. No.: 18/275,769

(22) PCT Filed: May 25, 2021
(86) PCT No.: PCT/JP2021/019792

§ 371 Date: Aug. 3, 2023

(51) Int. Cl. G06V 10/764; G06F 3/04842; G06F 3/14; G06V 20/52

(52) U.S. Cl. CPC G06V 10/764; G06F 3/04842; G06F 3/14; G06V 20/52

(57) ABSTRACT

An image processing apparatus includes: an acquisition unit that acquires plural person images, person identification information generated for each of the plural person images and provided to a person in the person image, and time series information indicating a time series of the plural person images; a classification unit that classifies the person image having the same person identification information into an identical group; a display control unit that simultaneously displays, on a display, at least one person image belonging to a target group being a processing target and an item input field for inputting information indicating a correction item to be executed for the target group; and a correction execution unit that decides a display position of the person image belonging to the target group by using the time series information, and the correction execution unit executes correction processing according to the information input in the item input field.

### TECHNICAL FIELD

The present invention relates to an image processing apparatus, an image processing method, and a program.

### BACKGROUND ART

In recent years, determination on a moving path of a person has been performed by processing a plurality of images. An apparatus executing such processing crops a person image from an image, and also classifies the person image being cropped, by each person. During the classification, the apparatus may include, in a group of a person image relating to a certain person, a person image of another person. In view of this, Patent Document 1 describes that an image processing system is provided with a correction means for correcting such an error.

Further, Patent Document 2 describes that, when a display apparatus displays a video from each of a plurality of cameras, and thereby a moving body being a tracking target is tracked, a tracking support apparatus executes the following processing. First, when a surveillant specifies a person being a tracking target, the tracking support apparatus sets the person being specified by the surveillant, as the tracking target. Subsequently, the tracking support apparatus sequentially selects a person with a highest risk score for each camera. Then, the tracking support apparatus extracts a video with the highest probability of capturing the person being set as the tracking target as a confirmation video for each camera, and displays, on a monitor, a time line screen on which the confirmation video is displayed. When an inappropriate confirmation video is found in a time line image, a surveillant performs an operation for instructing tracking result editing. Then, the tracking support apparatus displays a tracking result editing screen. On the screen, a video by a camera being associated with the confirmation video is displayed. On the screen, a surveillant performs an editing operation in such a way that a video display period of the confirmation video becomes an appropriate period.

### RELATED DOCUMENTS

### Patent Documents

Patent Document 1: International Patent Publication No. WO2014/045670
Patent Document 2: Japanese Patent Application Publication No. 2017-139701

### SUMMARY OF INVENTION

### Technical Problem

When an apparatus is caused to execute processing of classifying a person image by each person, the apparatus may cause various types of errors. An object of the present invention is to make it easier for a user to correct those plurality of types of errors.

### Solution to Problem

According to one aspect of the present invention, there is provided an image processing apparatus, including:
an acquisition unit that acquires a plurality of person images each including a person, person identification information being generated for each of the plurality of person images and being provided to a person included in the person image, and time series information indicating a time series of the plurality of person images;
a classification unit that classifies the person images having the person identification information being the same, into an identical group;
a display control unit that simultaneously displays, on a display, at least one person image belonging to a target group being the group being a processing target, and an item input field for inputting correction item information indicating a correction item to be executed for the target group, and also decides a display position of the person image belonging to the target group by using the time series information; and
a correction execution unit that executes correction processing according to information being input in the item input field.

According to one aspect of the present invention, there is provided an image processing method, including,
by a computer:
acquisition processing of acquiring a plurality of person images each including a person, person identification information being generated for each of the plurality of person images and being provided to a person included in the person image, and time series information indicating a time series of the plurality of person images;
classification processing of classifying the person image having the person identification information being the same, into an identical group;
display control processing of simultaneously displaying, on a display, at least one person image belonging to a target group being the group being a processing target, and an item input field for inputting correction item information indicating a correction item to be executed for the target group, and also deciding a display position of the person image belonging to the target group by using the time series information; and
correction execution processing of executing correction processing according to information being input in the item input field.

According to one aspect of the present invention, there is provided a program causing a computer to include:
an acquisition function of acquiring a plurality of person images each including a person, person identification information being generated for each of the plurality of person images and being provided to a person included in the person image, and time series information indicating a time series of the plurality of person images;
a classification function of classifying the person image having the person identification information being the same, into an identical group;
a display control function of simultaneously displaying, on a display, at least one person image belonging to a target group being the group being a processing target, and an item input field for inputting correction item information indicating a correction item to be executed for the target group, and also deciding a display position of the person image belonging to the target group by using the time series information; and
a correction execution function of executing correction processing according to information being input in the item input field.

### Advantageous Effects of Invention

According to one aspect of the present invention, a user can easily correct a plurality of errors that may be occurred in a case of classifying a person image by each person.

### BRIEF DESCRIPTION OF THE DRAWINGS

The object described above and other objects, features, and advantageous effects are further clarified in suitable example embodiments described below and the following drawings accompanying therewith.

FIG. 1 It is a diagram illustrating one example of a function configuration of an image processing apparatus according to a first example embodiment.

FIG. 2 It illustrates a first example of information stored in an image storage unit.

FIG. 3 It illustrates a second example of information stored in the image storage unit.

FIG. 4 It is a diagram illustrating a hardware configuration example of the image processing apparatus.

FIG. 5 It is a flowchart illustrating one example of processing executed by the image processing apparatus.

FIG. 6 It is a diagram illustrating one example of a confirmation screen displayed on a display in step S40 in FIG. 5.

FIG. 7 It is a flowchart illustrating a first example of processing executed in step S60 in FIG. 5.

FIG. 8 It is a diagram illustrating one example of a selection screen displayed on the display in step S110 in FIG. 7.

FIG. 9 It is a flowchart illustrating a second example of the processing executed in step S60 in FIG. 5.

FIG. 10 It is a diagram illustrating one example of a screen displayed on the display in step S220.

FIG. 11 It is a flowchart illustrating a third example of the processing executed in step S60 in FIG. 5.

FIG. 12 It is a diagram illustrating a modification example of the selection screen displayed on the display in step S110 in FIG. 7 and/or step S310 in FIG. 11.

FIG. 13 It is a flowchart illustrating a fourth example of the processing executed in step S60 in FIG. 5.

FIG. 14 It is a diagram illustrating a first example of a screen displayed on the display in step S410 in FIG. 13.

FIG. 15 It is a diagram illustrating a second example of the screen displayed on the display in step S410 in FIG. 13.

FIG. 16 It is a diagram illustrating one example of a function configuration of an image processing apparatus according to a second example embodiment.

### EXAMPLE EMBODIMENT

Example embodiments of the present invention are described below with reference to the drawings. Note that, in all the drawings, a similar constituent element is denoted with a similar reference sign, and description therefor is omitted as appropriate.

### First Example Embodiment

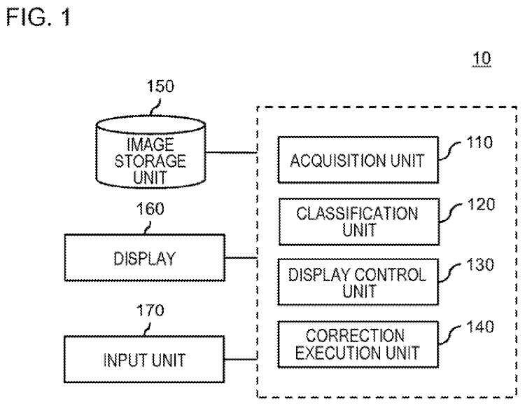

FIG. 1 is a diagram illustrating one example of a function configuration of an image processing apparatus 10 according to the present example embodiment. The image processing apparatus 10 processes a plurality of person images. Specifically, each of the plurality of person images includes a person, and includes person identification information (for example, a person ID) for identifying the person. The person identification information is allocated to each person by image recognition processing. In other words, even when the same person is captured in different person images from each other, the person images are provided with the same person identification information.

Herein, various errors may be occurred on association between a person image and person identification information. Further, when a person image is cropped from another image, an error may be occurred on the cropping. One example of the error is a case in which a region other than a person is cropped as a person image, a case in which a region even where a person exists is not cropped as a person image, or the like. A user uses the image processing apparatus 10 to correct such errors.

Note that, for example, a plurality of person images handled by the image processing apparatus 10 may be cropped from a plurality of frame images constituting the same moving image, or may be cropped from images generated by a plurality of different cameras (for example, a plurality of surveillance cameras) from each other. Further, at least part of the plurality of person images may be an image itself being generated by a camera.

Further, a flow line of a person can be determined by grouping person images associated with same person identification law and also using information relating to an image being a source of those person images. In other words, the image processing apparatus 10 is used as a part of a system for tracking a person by image processing.

As illustrated in FIG. 1, the image processing apparatus 10 includes an acquisition unit 110, a classification unit 120, a display control unit 130, and a correction execution unit 140.

The acquisition unit 110 acquires the plurality of person images and the person identification information that are described above, and time series information. The person identification information and the time series information are provided to each of the plurality of person images. The time series information indicates a time series of the plurality of person images. When the plurality of person images are cropped from a plurality of frame images constituting the same moving image, the time series information may indicate an order of the frame images being the source of each of the person images. Further, the time series information may be a photographing date (indicated in milliseconds in some cases) of a person image or an image being the source of the person image.

In the example illustrated in the present diagram, the acquisition unit 110 acquires the information described above from an image storage unit 150. One example of the information stored in the image storage unit 150 is described later with reference to another diagram.

The classification unit 120 classifies a person image having same person identification information into an identical group. Herein, the number of person images belonging to one group may be only one, but a plurality of person images belong to one group in most cases.

The display control unit 130 simultaneously displays, on a display 160, at least one person image belonging to a group being a processing target (hereinafter, referred to as a target group), and an item input field for inputting correction item information. Hereinafter, a screen displayed on the display 160 is referred to as a confirmation screen. The correction item information indicates a correction item to be executed for the target group. Examples of the correction item include division of the target group into a plurality of groups, integrating of another group collectively into the target group, and deletion of at least one person image from the target group. Further, When the plurality of person images are cropped from a plurality of frame images constituting the same moving image, the correction item may indicate cropping of a new person image to be included in the target group, from any of the frame images.

Further, the display control unit 130 decides a display position of the person image belonging to the target group by using the time series information. For example, when the plurality of person images belong to the target group, the display control unit 130 arranges the plurality of person images according to a time series.

The correction execution unit 140 executes correction processing according to information being input in the item input field. One example of the correction processing is described later with reference to another diagram.

The image processing apparatus 10 further includes the display 160 described above, and an input unit 170. The input unit 170 acquires various inputs that are performed by a user with respect to the image processing apparatus 10. Note that, when the display 160 is a touch panel, the display 160 may also function as the input unit 170. Further, the display 160 and the input unit 170 may be positioned outside of the image processing apparatus 10.

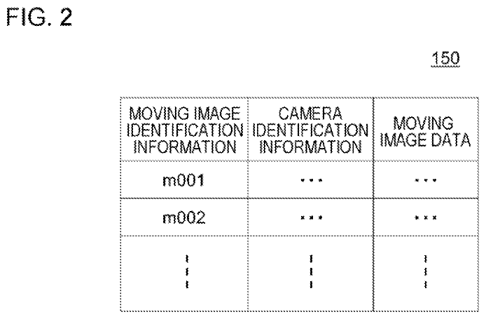

FIG. 2 illustrates a first example of information stored in the image storage unit 150. The image storage unit 150 stores an image being the source of the person image. In the example illustrated in the present diagram, for each moving image being the source of the person image, the image storage unit 150 stores information identifying the moving image (hereinafter, referred to as moving image identification information), information identifying a camera that generates the moving image (hereinafter, referred to as camera identification information), and moving image data (hereinafter, also referred to as a moving image in some cases).

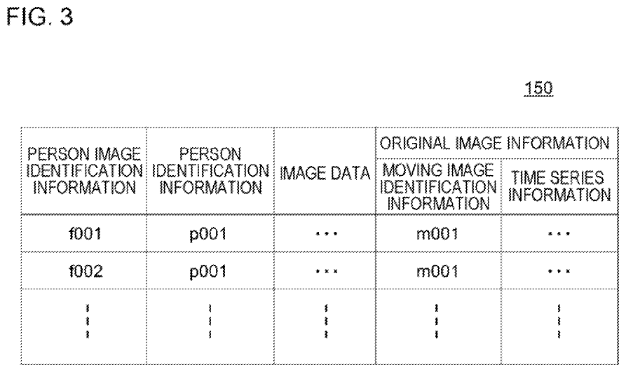

FIG. 3 illustrates a second example of information stored in the image storage unit 150. In addition to the information illustrated in FIG. 2, the image storage unit 150 also stores information relating to the person image. Specifically, for each person image, the image storage unit 150 stores information identifying the person image (hereinafter, referred to as person image identification information), person identification information relating to a person included in the person image, image data (hereinafter, also referred to as a person image in some cases), and information relating to an image from which the person image is cropped (hereinafter, referred to as original image information). One example of the original image information is the moving image identification information and the time series information. A frame image being the source of the person image is determined by the moving image identification information and the time series information.

Note that, some of the person images stored in FIG. 3 may be an image other than a person. This is because an error may be occurred during processing of cropping a person image from an image being the source.

Note that, although not illustrated, the image storage unit 150 may store various scores that are generated for each person image in the image processing. One example of those scores is a detection score, that is, a likelihood as a person, and a tracking score, that is, a likelihood of person determination information.

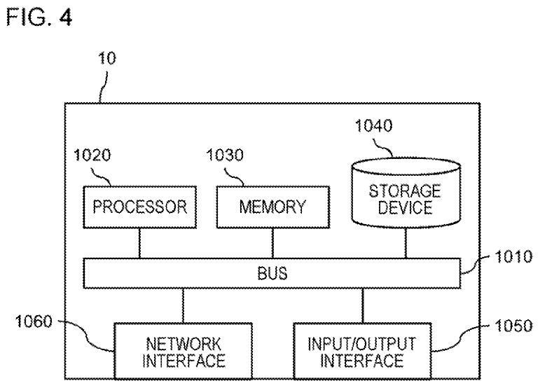

FIG. 4 is a diagram illustrating a hardware configuration example of the image processing apparatus 10. The image processing apparatus 10 includes a bus 1010, a processor 1020, a memory 1030, a storage device 1040, an input/output interface 1050, and a network interface 1060.

The bus 1010 is a data transmission path in which the processor 1020, the memory 1030, the storage device 1040, the input/output interface 1050, and the network interface 1060 transmit and receive data mutually. However, a method of connecting the processor 1020 and the like to one another is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module for achieving each function (for example, the acquisition unit 110, the classification unit 120, the display control unit 130, and the correction execution unit 140) of the image processing apparatus 10. When the processor 1020 reads each of the program modules on the memory 1030 and executes the read program module, each of the functions associated with each of the program modules is achieved. Further, the storage device 1040 may be utilized as the image storage unit 150.

The input/output interface 1050 is an interface for connecting the image processing apparatus 10 to various input/output devices. For example, the processor 1020 communicates with the display 160 and the input unit 170 via the input/output interface 1050.

The network interface 1060 is an interface for connecting the image processing apparatus 10 to a network. For example, the network is a local area network (LAN) or a wide area network (WAN). Wireless connection or wired connection may be adopted as a method by which the network interface 1060 is connected to the network.

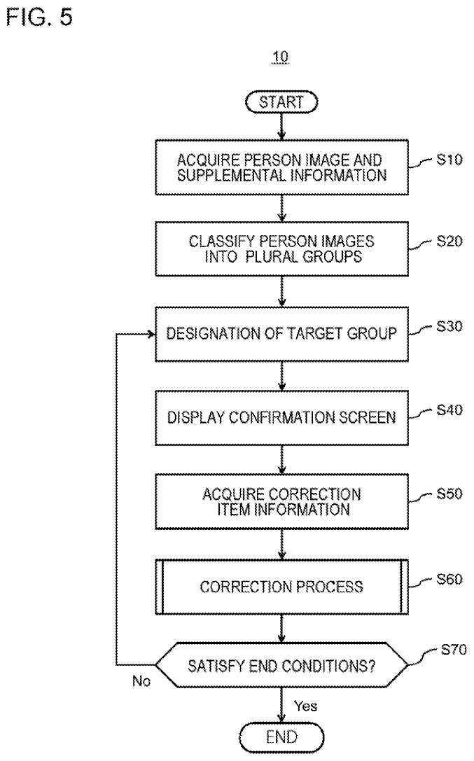

FIG. 5 is a flowchart illustrating one example of processing executed by the image processing apparatus 10. In the example illustrated in the present diagram, the image storage unit 150 stores the information illustrated in FIGS. 2 and 3, in advance.

First, the acquisition unit 110 reads out a plurality of person images and information added thereto (hereinafter, referred to as supplemental information) from the image storage unit 150. The supplemental information includes the person identification information and the original image information. As described above, the original image degree information includes the time series information. Further, when the plurality of person images are cropped from a same moving image, for example, when the plurality of person images that are read out by the acquisition unit 110 are associated with the same moving image identification information in the image storage unit 150, the acquisition unit 110 also reads out the moving image (for example, the moving image indicated by the moving image identification information associated with the person image) from the image storage unit 150 (step S10).

Subsequently, the classification unit 120 classifies the plurality of person images into a plurality of groups by using the person identification information. Specifically, the classification unit 120 integrates the plurality of person images having the same person identification information collectively into one group. Herein, when there is only one person image having the person identification information, the number of person images belonging to the group is one (step S20).

Subsequently, the display control unit 130 acquires information designating a target group, for example, person identification information associated with a group to be selected as the target group. The display control unit 130 may acquire the information from a user via the input unit 170. Further, the display control unit 130 may recognize all pieces of the person identification information acquired from the acquisition unit 110, and select one piece of the person identification information from the pieces of the person identification information (step S30).

Subsequently, the display control unit 130 displays the confirmation screen on the display 160. As described above, the confirmation screen includes at least one person image belonging to the target group and the item input field for inputting the correction item information. A specific example of the confirmation screen is described later with reference to another diagram (step S40).

A user of the image processing apparatus 10 uses the confirmation screen, and thereby recognizes a correction item to be executed for the target group. Further, a user inputs the correction item information in the item input field on the confirmation screen. The correction execution unit 140 acquires the correction item information (step S50). Further, the correction execution unit 140 recognizes the correction item indicated by the correction item information being acquired, and executes processing associated with the correction item (step S60). Details of the processing executed herein is described later with reference to another diagram. Further, the information stored in the image storage unit 150 is updated according to a result of the processing executed in step S60.

The image processing apparatus 10 repeats the processing illustrated in step S30 to step S60 until an end condition is satisfied (step S70). One example of the end condition is that a user inputs information indicating termination of correction to the input unit 170 or all the groups are selected, but is not limited thereto.

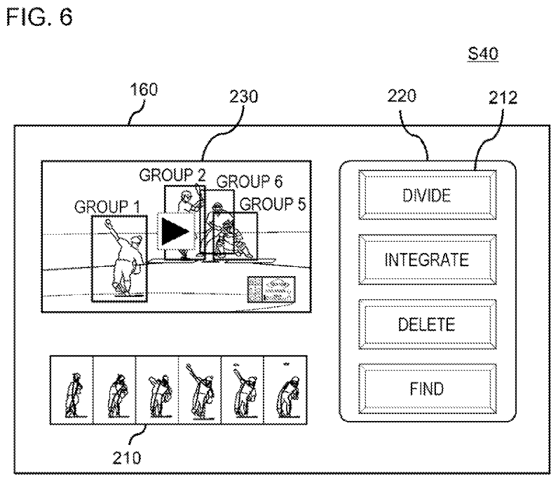

FIG. 6 is a diagram illustrating one example of the confirmation screen being displayed on the display 160 in step S40. The confirmation screen includes a person display region 210, an item input field 220, and a moving image reproduction field 230.

The person display region 210 is a region in which a person image belonging to the target group is displayed. The person display region 210 may display all the person images belonging to the target group, or may display only some of the person images. In the latter case, the display control unit 130 may select a frame image at a constant interval (for example, every 10 frames) in the time series, and display only a person image associated with the selected frame image on the person display region 210.

Further, the display control unit 130 may change a display method between a person image to be noticed and other person images. Items to be changed include the following items.
A rule for thinning (for example, a thinning interval) in a case of displaying only some of the person images
Presence or absence of a frame for emphasis
Presence or absence of at least one of a mark, a character, and a sentence

For example, the person image to be noticed is a person image being more likely to be removed from the target group. The image to be noticed is determined in the following manner, for example.
1) A person image having a low detection score, that is, a low likelihood as a person.
2) A person image having a low tracking score, that is, a low likelihood of person determination information.
3) A case in which a plurality of persons are captured in a frame image from which the person image is cropped
4) A case in which a pose of the person changes at a level equal to or more than a reference in former or later frame images
5) A person image having a clarity degree of a face being equal to or less than a reference value
6) A case in which there is a defect of information in a frame image being the source of a person image

Note that, in 6), specific examples of the defect of information are as follows.
A face is partially missing. For example, a face is partially covered with a mask, sunglasses, or the like.
There is a defective part in pose information. For example, a body is partially covered. One example that causes the covering is that a body is partially overlapped with at least one of personal belongings, another part of the body of the person (self-covering), and another person.

Further, a person image associated with the same person identification information is detected from former or later frame images of a certain frame image, but the person image associated with the person identification information may not be detected from the frame image (hereinafter, such a frame image is referred to as a defective frame). The person display region 210 may display the person image in the person display region 210 in such a way that a user can recognize presence of the defective frame. One example of the display is that a space is provided in a region being equivalent to the defective frame (that is, a blank space is provided) while aligning the plurality of person images in the same order as the frame images being the sources of each person image.

Further, in the person display region 210, the display control unit 130 may highlight and display the above-mentioned person image to be noticed. One example of the highlight and display is at least one of framing, coloring, marking, changing a size, having a mode for displaying only the person image to be noticed, and displaying the person image to be noticed in a line on one side (for example, on a right side or a left side) (sorting).

The item input field 220 displays a plurality of correction items in a selectable manner. In the example illustrated in the present diagram, the item input field 220 includes a plurality of buttons 212 associated with the plurality of correction items. In the example illustrated in the present diagram, the correction items are “divide”, “integrate”, “delete”, and “find”. The “divide” indicates division of the target group into a plurality of groups. The “integrate” indicates integrating of another group collectively into the target group. The “delete” indicates deletion of at least one person image from the target group. When the plurality of person images are cropped from a plurality of frame images constituting the same moving image, the “find” indicates cropping of a new person image to be included in the target group, from any of the frame images.

Note that, the item input field 220 may display the plurality of correction items in a selectable manner in a pull-down form.

the moving image reproduction field 230 is a field for reproducing the moving image being read out in step S10. When the moving image reproduction field 230 is displayed simultaneously with the person display region 210 and the item input field 220, a user is more easily able to find an error relating to the target group. Note that, although not illustrated, the moving image reproduction field 230 may include various operation buttons such as a reproduction start button, a pause button, a fast-forwarding button, and a rewinding button.

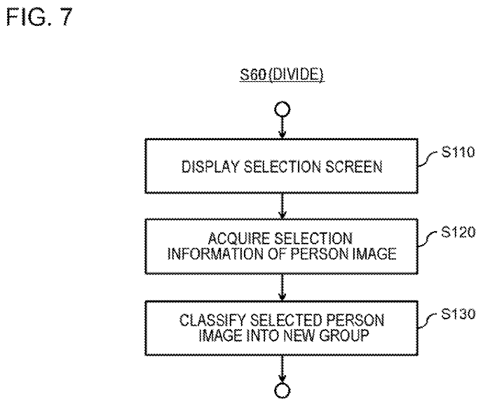

FIG. 7 is a flowchart illustrating a first example of the processing executed in step S60 in FIG. 5. The present diagram is associated with a case in which the “divide” is selected in FIG. 6.

First, the correction execution unit 140 displays, on the display 160, the plurality of person images belonging to the target group in a selectable state (step S110). Hereinafter, an image displayed on the display 160 herein is referred to as a selection screen. A user of the image processing apparatus 10 selects a person image to be divided as another group while confirming the plurality of person images being displayed on the selection screen. Herein, a user may select a plurality of person images, or may select one person image. Further, a user may designate a boundary between a person image to be remained in the target group and a person image to be divided as another group. Further, there are a plurality of person images to be divided as another group, the plurality of person images are consecutive in most cases. Thus, a user may designate a section of person images (for example, a first person image and a last person image) to be divided as another group (step S120). Subsequently, the correction execution unit 140 provides the selected person image with new same person identification information. With this, the selected person image is classified into a new group (step S130).

Note that, a user may select a person image to be remained in the target group in step S120. In this case, the correction execution unit 140 provides a person image not being selected with new same person identification information, in step S130.

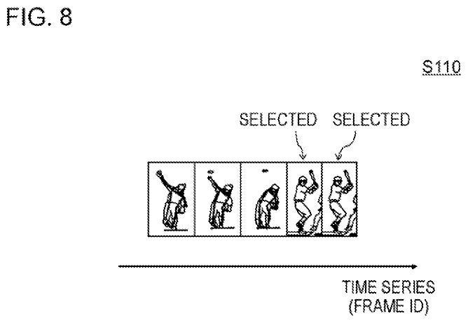

FIG. 8 is a diagram illustrating one example of the selection screen being displayed on the display 160 in step S110 in FIG. 7. In the example illustrated in the present diagram, the plurality of person images are cropped from a plurality of frame images constituting the same moving image. Further, the plurality of person images are arranged in the time series order. A user determines a person image to be divided as another group by viewing the screen, and selects the person image being determined.

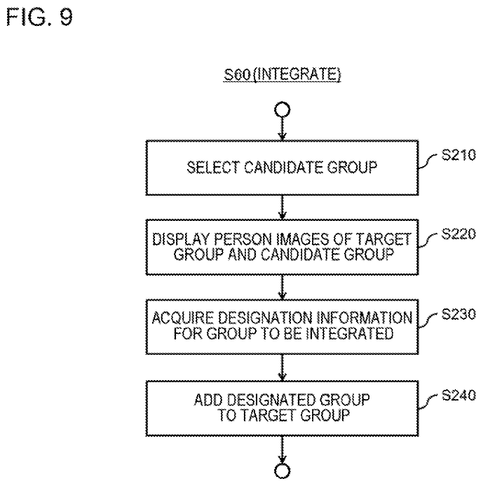

FIG. 9 is a flowchart illustrating a second example of the processing executed in step S60 in FIG. 5. The present diagram is associated with a case in which the “integrate” is selected in FIG. 6.

First, the correction execution unit 140 selects at least one group being a candidate (hereinafter, referred to as a candidate group). As one example, the correction execution unit 140 computes a similarity degree between a person belonging to the target group and a person belonging to another group, and selects, as the candidate group, a group having the similarity degree falling within a reference range (for example, equal to or more than a reference value) (step S210).

The reference range used herein is set based on information acquired from an outside. As one example, a user of the image processing apparatus 10 inputs setting information relating to the reference range in the correction execution unit 140 via the input unit 170. In this manner, a user can set the reference range of the similarity degree as appropriate according to a state (for example, sharpness or a resolution) of the person image.

Subsequently, the correction execution unit 140 simultaneously displays, on the display 160, at least part of the person images belonging to the target group and at least part of the person images belonging to the candidate group (step S220). A user of the image processing apparatus 10 can recognize a group to be integrated into the target group by viewing the screen. Further, a user inputs, to the image processing apparatus 10, information designating a group to be integrated into the target group (hereinafter, referred to as group designation information). As one example, a user arranges a cursor on a person image belonging to a group to be designated, and performs a predetermined input to an input device such as a mouse. With this, the correction execution unit 140 is capable of acquiring the group designation information (step S230).

Further, the correction execution unit 140 selects a group indicated by the group designation information, and integrates the group being selected into the target group. As one example, the correction execution unit 140 changes the person identification information associated with the group being selected, to person designation information associated with a target image (step S240).

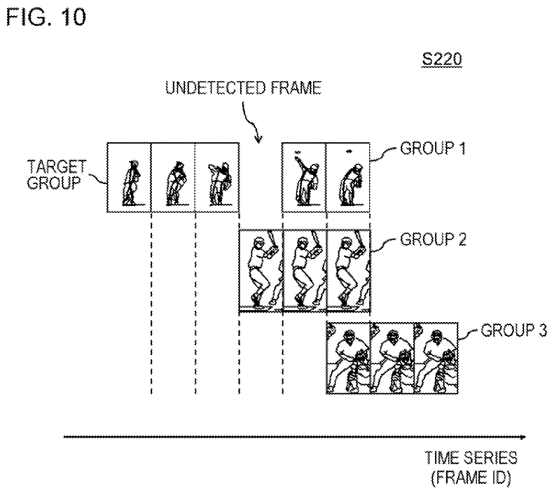

FIG. 10 is a diagram illustrating one example of a screen displayed on the display 160 in step S220. As described above, in step S220, the correction execution unit 140 simultaneously displays, on the display 160, at least part of the person images belonging to the target group and at least part of the person images belonging to the candidate group.

In this state, the correction execution unit 140 decides a display position of a person image belonging to the target group and a display position of a person image belonging to another group by using the time series information. For example, when a person image belonging to the target group and a person image belonging to each candidate group are cropped from the same moving image, the correction execution unit 140 arranges the person images of the plurality of person images that are cropped from the same frame image, at the same position in a first direction (for example, a horizontal direction or a vertical direction).

Further, in the example illustrated in the present diagram, the correction execution unit 140 selects a plurality of candidate groups (groups 1 to 3). The correction execution unit 140 decides an arrangement position of a person image belonging to each of the candidate groups, by using a difference between a position of the person image belonging to the candidate group within the frame image and a position of the person image belonging to the target group within the frame image. When a person belonging to the target group and a person belonging to a certain candidate group are the same, the positions of the persons within the frame image are substantially the same, or the difference therebetween is small. Thus, as the difference described above is reduced, the correction execution unit 140 arranged the person image belonging to the candidate group at a position closer to the person image belonging to the target group. In this manner, a user of the image processing apparatus 10 can easily recognize a group to be selected. Note that, in the example illustrated in the present diagram, the correction execution unit 140 decides a position in a direction intersecting with (for example, orthogonal to) the first direction described above, by using the difference described above.

Further, the correction execution unit 140 may set the display positions of the plurality of candidate groups by using the similarity degree used in step S210. For example, as the similarity degree is higher, the correction execution unit 140 may display the candidate group at a position closer to the target group.

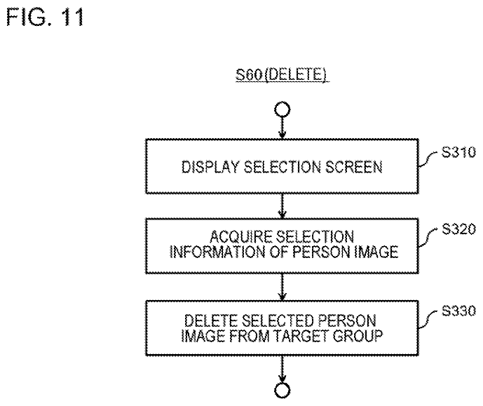

FIG. 11 is a flowchart illustrating a third example of the processing executed in step S60 in FIG. 5. The present diagram is associated with a case in which the “delete” is selected in FIG. 6.

The correction execution unit 140 displays, on the display 160, the plurality of person images belonging to the target group in a selectable manner (step S310). A screen displayed herein is similar to the selection screen illustrated in FIG. 8. Subsequently, a user of the image processing apparatus 10 selects a person image to be deleted from the target group while confirming the plurality of person images being displayed on the selection screen. Herein, a user may select a plurality of person images, or may select one person image (step S320). Subsequently, the correction execution unit 140 deletes the person identification information from the person image being selected. With this, the person image being selected is deleted from the target group (step S330).

Note that, in step S330, the correction execution unit 140 may delete the person image itself being selected. One example of the person image being selected herein is an image other than a person.

Further, in step S320, a user may select a person image to be remained in the target group. In this case, in step S130, the correction execution unit 140 deletes person identification information from a person image not being selected.

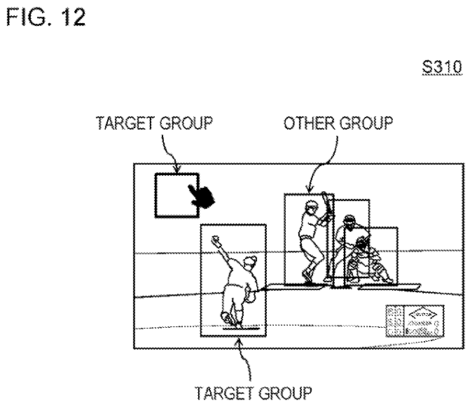

FIG. 12 is a diagram illustrating a modification example of the selected screen displayed on the display 160 in step S110 in FIG. 7 and/or step S310 in FIG. 11. In the example illustrated in the present diagram, the correction execution unit 140 displays, on the display 160, a moving image being the source of the person image. Herein, the correction execution unit 140 displays, in the moving image, a mark indicating a position of the person image and person identification information associated with the person image in an overlapping manner. A user selects a person image by selecting at least one of the mark and the person identification information. The correction execution unit 140 receives information indicating the selection result as a selection result of the person image.

Note that, the correction execution unit 140 may display, on the display 160, a display field for the moving image being illustrated in FIG. 12, simultaneously with a display field for the person image being illustrated in FIG. 8.

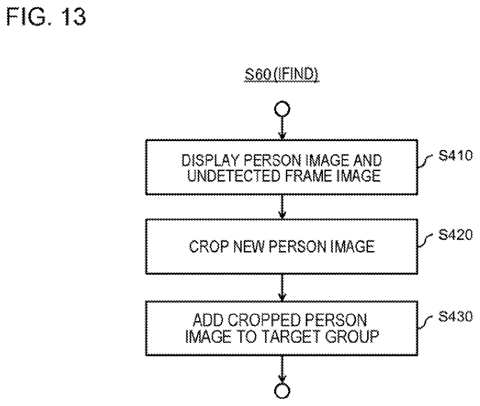

FIG. 13 is a flowchart illustrating a fourth example of the processing executed in step S60 in FIG. 5. The present diagram is associated with a case in which the “find” is selected in FIG. 6.

First, the correction execution unit 140 determines an undetected frame image. Among a plurality of frame images constituting a moving image, the undetected frame image is a frame image from which a person image belonging to the target group is not cropped. Further, the correction execution unit 140 displays, on the display 160, at least part of the person images belonging the target group and the undetected frame image (step S410).

Subsequently, the correction execution unit 140 crops a person image to be newly added to the target group, from the undetected frame image (step S420).

Herein, the correction execution unit 140 may crop a person candidate region from the undetected frame image by using information relating to a person image belonging to the target group (hereinafter, referred to as a reference person image). As one example, the correction execution unit 140 crops the person candidate region from the undetected frame image by using a position of the reference person image within the frame image (hereinafter, referred to as a determined position). After that, the correction execution unit 140 determines a person candidate region included in the undetected frame image, executes an image analysis for the person candidate region, and estimates a person score and a similarity degree score with the target group. Further, when both the scores satisfy references (for example, equal to or more than reference values), the correction execution unit 140 crops a person region from the person candidate region.

Further, a user may designate a region to be regarded as a new person image from the undetected frame image. In this case, the correction execution unit 140 executes similar processing while regarding the region as the person candidate region described above.

Further, the correction execution unit 140 adds the person image being cropped to the target group. For example, the correction execution unit 140 associates the person image being cropped, with in-object identification information being a same to that in the target group (step S430).

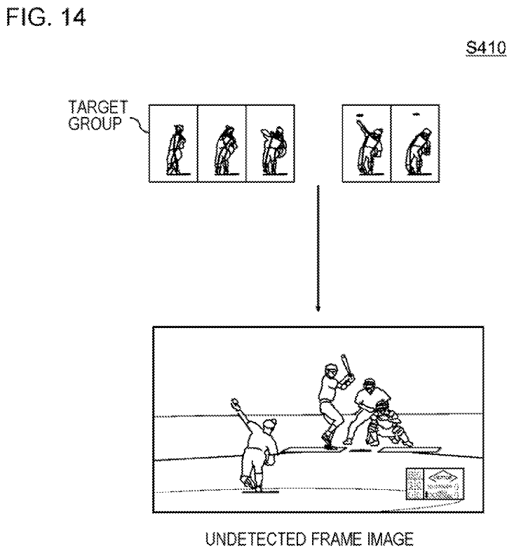

FIG. 14 is a diagram illustrating a first example of a screen displayed on the display 160 in step S410 in FIG. 13. In the example illustrated in the present diagram, the plurality of person images belonging to the target group are cropped from the same moving image. Further, the correction execution unit 140 aligns the plurality of person images belonging to the target group, according to an order of the frame images being the source of the person images. Herein, the correction execution unit 140 provides a space for a region being equivalent to the undetected frame image. Further, the undetected frame image is displayed in association with the space

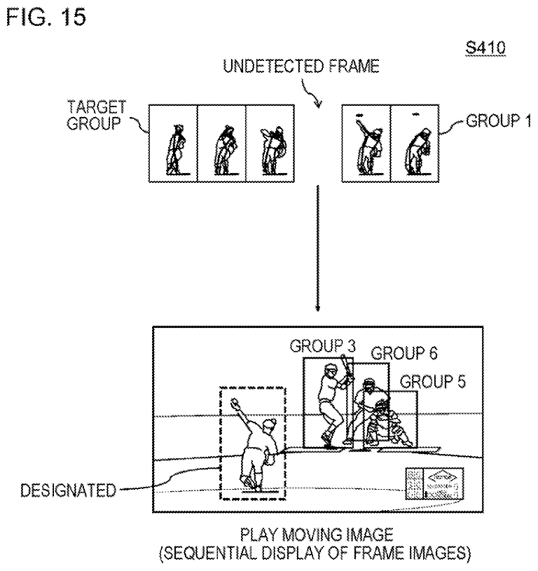

FIG. 15 is a diagram illustrating a second example of the screen displayed on the display 160 in step S410 in FIG. 13. The example illustrated in the present diagram is similar to the example illustrated in FIG. 14, except that a moving image is displayed in place of the undetected frame image. Herein, the correction execution unit 140 displays, in the moving image, a mark indicating a position of the person image and person identification information associated with the person image in an overlapping manner. With this, a user can easily recognize a person image to be newly cropped, that is, a person image being undetected.

According to the present example embodiment described above, a user of the image processing apparatus 10 can easily correct a plurality of errors that may be occurred in a case of classifying a person image by each person.

### Second Example Embodiment

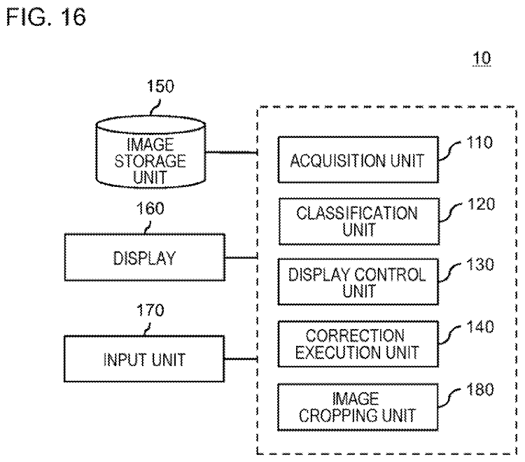

FIG. 16 is a diagram illustrating one example of a function configuration of an image processing apparatus 10 according to the present example embodiment. The image processing apparatus 10 illustrated in the present drawing is similar to the image processing apparatus 10 according to the first example embodiment, except that an image cropping unit 180 is further included.

The image cropping unit 180 generates a person image by processing a moving image stored in an image storage unit 150. Further, the image cropping unit 180 causes the image storage unit 150 to store information illustrated in FIG. 3.

According to the present example embodiment, a user of the image processing apparatus 10 can easily correct a plurality of errors that may be occurred in a processing result of the image cropping unit 180.

While the example embodiments of the present invention are described above with reference to the drawings, those are exemplifications of the present invention, and various configurations other than those described above may be adopted.

Further, in the plurality of flowcharts used in the description given above, the plurality of steps (pieces of processing) are described in order, but the execution order of the steps executed in each of the example embodiments is not limited to the described order. In each of the example embodiments, the order of the illustrated steps may be changed without interfering with the contents. Further, the example embodiments described above may be combined with each other within a range in which the contents do not contradict with each other.

The whole or some of the example embodiments described above can be described as, but not limited to, the following supplementary notes.
1. An image processing apparatus, including:
   an acquisition unit that acquires a plurality of person images each including a person, person identification information being generated for each of the plurality of person images and being provided to a person included in the person image, and time series information indicating a time series of the plurality of person images;
   a classification unit that classifies the person image having the person identification information being the same, into an identical group;
   a display control unit that simultaneously displays, on a display, at least one person image belonging to a target group being the group being a processing target, and an item input field for inputting correction item information indicating a correction item to be executed for the target group, and also decides a display position of the person image belonging to the target group by using the time series information; and
   a correction execution unit that executes correction processing according to information being input in the item input field.
2. The image processing apparatus according to supplementary note 1, wherein
   the display control unit displays the person image satisfying a predetermined condition and another person image among the plurality of person images, in different methods.
3. The image processing apparatus according to supplementary note 1 or 2, wherein
   the display control unit displays a plurality of correction items in the item input field in a selectable manner.
4. The image processing apparatus according to any one of supplementary notes 1 to 3, wherein
   the plurality of person images are cropped from a plurality of frame images constituting a moving image, and
   the display control unit further displays, on the display, a moving image reproduction field for reproducing the moving image simultaneously with the person image and the item input field.
5. The image processing apparatus according to any one of supplementary notes 1 to 4, wherein
   information being input in the item input field indicates division of the target group into a plurality of groups, and,
   as the correction processing, the correction execution unit causes, among the person images belonging to the target group, the person image being selected or the person image not being selected to belong to a new group.
6. The image processing apparatus according to any one of supplementary notes 1 to 4, wherein
   information being input in the item input field indicates integrating of another group collectively into the target group,
   as the correction processing, the correction execution unit
      selects at least one of candidate groups by using the person image belonging to the target group, and displays at least part of the person images belonging to the candidate group, and
      selects, from the candidate groups, a group to be integrated into the target group according to information being input from an outside, and adds the group being selected to the target group.
7. The image processing apparatus according to supplementary note 6, wherein
   the correction execution unit
      selects, as the candidate group, the group including the person image similar to the person image belonging to the target group, and
      sets a reference range of a similarity degree for selecting the candidate group, based on information being acquired from an outside.
8. The image processing apparatus according to supplementary note 6 or 7, wherein
   the correction execution unit decides a display position of the person image belonging to the target group and a display position of the person image belonging to the candidate group, by using the time series information.
9. The image processing apparatus according to any one of supplementary notes 6 to 8, wherein
   the plurality of person images are cropped from a plurality of frame images constituting a moving image, and,
   when a plurality of the candidate groups are selected, the correction execution unit decides a display position of the person image belonging to each of the plurality of candidate groups by using a difference between a position of the person image belonging to the candidate group within the frame image and a position of the person image belonging to the target group within the frame image.
10. The image processing apparatus according to any one of supplementary notes 1 to 3, wherein
   information being input in the item input field indicates deletion of at least one person image from the target group, and,
   as the correction processing, the correction execution unit deletes, from the target group, among the person images belonging to the target group, the person image being selected or the person image not being selected.
11. The image processing apparatus according to supplementary note 4 or 10, wherein
   the plurality of person images are cropped from a plurality of frame images constituting a moving image, and
   the correction execution unit
      displays the moving image, and also displays, in the moving image, a mark indicating a position of the person image and the person identification information associated with the person image in an overlapping manner, and
      receives selection of at least one of the mark and the person identification information, as selection of the person image.
12. The image processing apparatus according to any one of supplementary notes 1 to 3, wherein
   the plurality of person images are cropped from a plurality of frame images constituting a moving image,
   information being input in the item input field indicates that a new person image to be included in the target group is cropped from any of the frame images, and
   the correction execution unit
      displays the frame image from which the person image belonging to the target group is not cropped, and
      crops the new person image from the frame image.
13. The image processing apparatus according to supplementary note 12, wherein
   the correction execution unit crops the new person image by using information relating to the person image included in the target group.
14. The image processing apparatus according to supplementary note 12, wherein
   the correction execution unit crops the new person image by using an input from a user.
15. The image processing apparatus according to any one of supplementary notes 12 to 14, wherein
   the display control unit
      displays the plurality of person images belonging to the target group in time series order, and
      making a space for a position being equivalent to the frame image from which the person image belonging to the target group is not cropped.
16. An image processing method, including,
   by a computer:
   acquisition processing of acquiring a plurality of person images each including a person, person identification information being generated for each of the plurality of person images and being provided to a person included in the person image, and time series information indicating a time series of the plurality of person images;
   classification processing of classifying the person image having the person identification information being the same, into an identical group;
   display control processing of simultaneously displaying, on a display, at least one person image belonging to a target group being the group being a processing target, and an item input field for inputting correction item information indicating a correction item to be executed for the target group, and also deciding a display position of the person image belonging to the target group by using the time series information; and
   correction execution processing of executing correction processing according to information being input in the item input field.
17. The image processing method according to supplementary note 16, further including,
   by the computer, in the display control processing,
   displaying the person image satisfying a predetermined condition and another person image among the plurality of person images, in different methods.
18. The image processing method according to supplementary note 16 or 17, further including,
   by the computer, in the display control processing,
   displaying a plurality of correction items in the item input field in a selectable manner.
19. The image processing method according to any one of supplementary notes 16 to 18, wherein
   the plurality of person images are cropped from a plurality of frame images constituting a moving image,
   the image processing method further including,
   by the computer, in the display control processing,
   displaying, on the display, a moving image reproduction field for reproducing the moving image simultaneously with the person image and the item input field.
20. The image processing method according to any one of supplementary notes 16 to 19, wherein
   information being input in the item input field indicates division of the target group into a plurality of groups,
   the image processing method further including,
   by the computer,
   as the correction processing, causing, among the person images belonging to the target group, the person image being selected or the person image not being selected to belong to a new group.
21. The image processing method according to any one of supplementary notes 16 to 19, wherein
   information being input in the item input field indicates integrating another group collectively into the target group,
   the image processing method further including,
   by the computer, as the correction processing:
      selecting at least one of candidate groups by using the person image belonging to the target group, and displaying at least part of the person images belonging to the candidate group; and
      selecting, from the candidate groups, a group to be integrated into the target group according to information being input from an outside, and adding the group being selected to the target group.
22. The image processing method according to supplementary note 21, further including,
   by the computer, in the correction execution processing:
      selecting, as the candidate group, the group including the person image similar to the person image belonging to the target group; and
      setting a reference range of a similarity degree for selecting the candidate group, based on information being acquired from an outside.
23. The image processing method according to supplementary note 21 or 22, further including,
   by the computer, in the correction execution processing,
   deciding a display position of the person image belonging to the target group and a display position of the person image belonging to the candidate group, by using the time series information.
24. The image processing method according to any one of supplementary notes 21 to 23, wherein
   the plurality of person images are cropped from a plurality of frame images constituting a moving image,
   the image processing method further including,
   by the computer, in the correction execution processing,
   when a plurality of the candidate groups are selected, deciding a display position of the person image belonging to each of the plurality of candidate groups by using a difference between a position of the person image belonging to the candidate group within the frame image and a position of the person image belonging to the target group within the frame image.
25. The image processing method according to any one of supplementary notes 16 to 18, wherein
   information being input in the item input field indicates deletion of at least one person image from the target group,
   the image processing method further including,
   by the computer,
   as the correction processing, deleting, from the target group, among the person images belonging to the target group, the person image being selected or the person image not being selected.
26. The image processing method according to supplementary note 19 or 25, wherein
   the plurality of person images are cropped from a plurality of frame images constituting a moving image,
   the image processing method further including,
   by the computer, in the correction execution processing:
      displaying the moving image, and also displaying, in the moving image, a mark indicating a position of the person image and the person identification information associated with the person image in an overlapping manner; and
      receiving selection of at least one of the mark and the person identification information, as selection of the person image.
27. The image processing method according to any one of supplementary notes 16 to 18, wherein
   the plurality of person images are cropped from a plurality of frame images constituting a moving image, and
   information being input in the item input field indicates that a new person image to be included in the target group is cropped from any of the frame images,
   the image processing method further including,
   by the computer, in the correction execution processing:
      displaying the frame image from which the person image belonging to the target group is not cropped; and
      cropping the new person image from the frame image.
28. The image processing method according to supplementary note 27, further including,
   by the computer, in the correction execution processing,
   cropping the new person image by using information relating to the person image included in the target group.
29. The image processing method according to supplementary note 27, further including,
   by the computer, tin the correction execution processing,
   cropping the new person image by using an input from a user.
30. The image processing method according to any one of supplementary notes 27 to 29, further including,
   by the computer, in the display control processing:
      displaying the plurality of person images belonging to the target group in time series order; and
      making a space for a position being equivalent to the frame image from which the person image belonging to the target group is not cropped.
31. A program causing a computer to include:
   an acquisition function of acquiring a plurality of person images each including a person, person identification information being generated for each of the plurality of person images and being provided to a person included in the person image, and time series information indicating a time series of the plurality of person images;
   a classification function of classifying the person image having person identification information being the same, into an identical group;
   a display control function of simultaneously displaying, on a display, at least one person image belonging to a target group being the group being a processing target, and an item input field for inputting correction item information indicating a correction item to be executed for the target group, and also deciding a display position of the person image belonging to the target group by using the time series information; and
   a correction execution function of executing correction processing according to information being input in the item input field.
32. The program according to supplementary note 31, wherein
   the display control function displays the person image satisfying a predetermined condition and another person image among the plurality of person images, in different methods.
33. The program according to supplementary note 31 or 32, wherein
   the display control function displays a plurality of correction items in the item input field in a selectable manner.
34. The program according to any one of supplementary notes 31 to 33, wherein
   the plurality of person images are cropped from a plurality of frame images constituting a moving image, and
   the display control function further displays, on the display, a moving image reproduction field for reproducing the moving image simultaneously with the person image and the item input field.
35. The program according to any one of supplementary notes 31 to 34, wherein
   information being input in the item input field indicates division of the target group into a plurality of groups, and,
   as the correction processing, the correction execution function causes, among the person images belonging to the target group, the person image being selected or the person image not being selected to belong to a new group.
36. The program according to any one of supplementary notes 31 to 34, wherein
   information being input in the item input field indicates integrating of another group collectively into the target group,
   as the correction processing, the correction execution function
      selects at least one of candidate groups by using the person image belonging to the target group, and displaying at least part of the person images belonging to the candidate group, and
      selects, from the candidate groups, a group to be integrated into the target group according to information being input from an outside, and adds the group being selected to the target group.
37. The program according to supplementary note 36, wherein
   the correction execution function
      selects, as the candidate group, the group including the person image similar to the person image belonging to the target group, and
      sets a reference range of a similarity degree for selecting the candidate group, based on information being acquired from an outside.
38. The program according to supplementary note 36 or 37, wherein
   the correction execution function decides a display position of the person image belonging to the target group and a display position of the person image belonging to the candidate group, by using the time series information.
39. The program according to any one of supplementary notes 36 to 38, wherein
   the plurality of person images are cropped from a plurality of frame images constituting a moving image, and,
   when a plurality of the candidate groups are selected, the correction execution function decides a display position of the person image belonging to each of the plurality of candidate groups by using a difference between a position of the person image belonging to the candidate group within the frame image and a position of the person image belonging to the target group within the frame image.
40. The program according to any one of supplementary notes 31 to 33, wherein
   information being input in the item input field indicates deletion of at least one person image from the target group, and,
   as the correction processing, the correction execution function deletes, from the target group, among the person images belonging to the target group, the person image being selected or the person image not being selected.
41. The program according to supplementary note 34 or 40, wherein
   the plurality of person images are cropped from a plurality of frame images constituting a moving image, and
   the correction execution function
      displays the moving image, and also displays, in the moving image, a mark indicating a position of the person image and the person identification information associated with the person image in an overlapping manner, and
      receives selection of at least one of the mark and the person identification information, as selection of the person image.
42. The program according to any one of supplementary notes 31 to 33, wherein
   the plurality of person images are cropped from a plurality of frame images constituting a moving image,
   information being input in the item input field indicates that a new person image to be included in the target group is cropped from any of the frame images, and
   the correction execution function
      displays the frame image from which the person image belonging to the target group is not cropped, and
      crops the new person image from the frame image.
43. The program according to supplementary note 42, wherein
   the correction execution function crops the new person image by using information relating to the person image included in the target group.
44. The program according to supplementary note 42, wherein
   the correction execution function crops the new person image by using an input from a user.
45. The program according to any one of supplementary notes 42 to 44, wherein
   the display control function
      displays the plurality of person images belonging to the target group in time series order, and
      making a space for a position being equivalent to the frame image from which the person image belonging to the target group is not cropped.

### REFERENCE SIGNS LIST

10 Image processing apparatus
110 Acquisition unit
120 Classification unit
130 Display control unit
140 Correction execution unit
150 Image storage unit
160 Display
170 Input unit
180 Image cropping unit
210 Person display region
212 Button
220 Item input field
230 Moving image reproduction field

What is claimed is:

1. An image processing apparatus, comprising:
at least one memory configured to store instructions; and
at least one processor configured to execute the instructions to:
acquire a plurality of person images each including a person, person identification information being generated for each of the plurality of person images and being provided to a person included in the person image, and time series information indicating a time series of the plurality of person images;
classify the person images having the person identification information being the same, into an identical group;
simultaneously display, on a display, at least one person image belonging to a target group being the group being a processing target, and an item input field for inputting correction item information indicating a correction item to be executed for the target group, and also decide a display position of the person image belonging to the target group by using the time series information; and
execute correction processing according to the correction item information being input in the item input field.

2. The image processing apparatus according to claim 1, wherein
wherein the at least one processor is further configured to execute the instructions to
display the person image satisfying a predetermined condition and another person image among the plurality of person images, in different methods.

3. The image processing apparatus according to claim 1, wherein
wherein the at least one processor is further configured to execute the instructions to
display a plurality of correction items in the item input field in a selectable manner.

4. The image processing apparatus according to claim 1, wherein
the plurality of person images are cropped from a plurality of frame images constituting a moving image, and
wherein the at least one processor is further configured to execute the instructions to
further display, on the display, a moving image reproduction field for reproducing the moving image simultaneously with the person image and the item input field.

5. The image processing apparatus according to claim 1, wherein
the correction item information being input in the item input field indicates division of the target group into a plurality of groups, and,
wherein the at least one processor is further configured to execute the instructions to
as the correction processing, cause, among the person images belonging to the target group, the person image being selected or the person image not being selected to belong to a new group.

6. The image processing apparatus according to claim 1, wherein
the correction item information being input in the item input field indicates integrating of another group collectively into the target group,
wherein the at least one processor is further configured to execute the instructions to
as the correction processing,
select at least one of candidate groups by using the person image belonging to the target group, and display at least part of the person images belonging to the candidate group, and
select, from the candidate groups, a group to be integrated into the target group according to information being input from an outside, and add the group being selected to the target group.

7. The image processing apparatus according to claim 6, wherein
the at least one processor is further configured to execute the instructions to
select, as the candidate group, the group including the person image similar to the person image belonging to the target group, and
set a reference range of a similarity degree for selecting the candidate group, based on information being acquired from an outside.

8. The image processing apparatus according to claim 6, wherein
the at least one processor is further configured to execute the instructions to
decide a display position of the person image belonging to the target group and a display position of the person image belonging to the candidate group, by using the time series information.

9. The image processing apparatus according to claim 6, wherein
the plurality of person images are cropped from a plurality of frame images constituting a moving image, and,
wherein the at least one processor is further configured to execute the instructions to
when a plurality of the candidate groups are selected, decide a display position of the person image belonging to each of the plurality of candidate groups by using a difference between a position of the person image belonging to the candidate group within the frame image and a position of the person image belonging to the target group within the frame image.

10. The image processing apparatus according to claim 1, wherein
the correction item information being input in the item input field indicates deletion of at least one person image from the target group, and,
wherein the at least one processor is further configured to execute the instructions to
as the correction processing, delete, from the target group, among the person images belonging to the target group, the person image being selected or the person image not being selected.

11. The image processing apparatus according to claim 4, wherein
the plurality of person images are cropped from a plurality of frame images constituting a moving image, and
wherein the at least one processor is further configured to execute the instructions to
display the moving image, and also displays, in the moving image, a mark indicating a position of the person image and the person identification information associated with the person image in an overlapping manner, and
receive selection of at least one of the mark and the person identification information, as selection of the person image.

12. The image processing apparatus according to claim 1, wherein
the plurality of person images are cropped from a plurality of frame images constituting a moving image,
the correction item information being input in the item input field indicates that a new person image to be included in the target group is cropped from any of the frame images, and
wherein the at least one processor is further configured to execute the instructions to
display the frame image from which the person image belonging to the target group is not cropped, and
crop the new person image from the frame image.

13. The image processing apparatus according to claim 12, wherein
wherein the at least one processor is further configured to execute the instructions to
crop the new person image by using information relating to the person image included in the target group.

14. The image processing apparatus according to claim 12, wherein
wherein the at least one processor is further configured to execute the instructions to
crop the new person image by using an input from a user.

15. The image processing apparatus according to claim 12, wherein
the at least one processor is further configured to execute the instructions to
display the plurality of person images belonging to the target group in time series order, and
make a space for a position being equivalent to the frame image from which the person image belonging to the target group is not cropped.

16. An image processing method, comprising,
by a computer:
acquisition processing of acquiring a plurality of person images each including a person, person identification information being generated for each of the plurality of person images and being provided to a person included in the person image, and time series information indicating a time series of the plurality of person images;
classification processing of classifying the person image having the person identification information being the same, into an identical group;
display control processing of simultaneously displaying, on a display, at least one person image belonging to a target group being the group being a processing target, and an item input field for inputting correction item information indicating a correction item to be executed for the target group, and also deciding a display position of the person image belonging to the target group by using the time series information; and
correction execution processing of executing correction processing according to information being input in the item input field.

17. A non-transitory computer-readable storage medium storing a program causing a computer to:
acquire a plurality of person images each including a person, person identification information being generated for each of the plurality of person images and being provided to a person included in the person image, and time series information indicating a time series of the plurality of person images;
classify the person image having the person identification information being the same, into an identical group;
simultaneously display, on a display, at least one person image belonging to a target group being the group being a processing target, and an item input field for inputting correction item information indicating a correction item to be executed for the target group, and also decide a display position of the person image belonging to the target group by using the time series information; and
execute correction processing according to the correction item information being input in the item input field.
